(19) United States
(12) Patent Application Publication
(10) Pub. No.: US 2024/0219171 A1
(43) Pub. Date: Jul. 4, 2024

(54) METHOD FOR ESTIMATING THE GEOMETRY OF A REFLECTIVE SURFACE OF AN OBJECT

(71) Applicants: OFFICE NATIONAL D'ETUDES ET DE RECHERCHES AEROSPATIALES, PALAISEAU (FR); SAFRAN REOSC, SAINT PIERRE DU PERRAY (FR)

(72) Inventors: Hugo JONQUIERE, MOISSY-CRAMAYEL (FR); Laurent MUGNIER, PALAISEAU (FR); Renaud MERCIER-YTHIER, MOISSY-CRAMAYEL (FR)

(21) Appl. No.: 18/557,764

(22) PCT Filed: Apr. 27, 2022
(86) PCT No.: PCT/EP2022/061279

§ 371 Date: Oct. 27, 2023

(30) Foreign Application Priority Data
Apr. 28, 2021 (FR) FR2104441

(51) Int. Cl. G01B 11/24

(52) U.S. Cl. CPC G01B 11/24

(57) ABSTRACT

Method for estimating a geometry of a reflective surface, which method comprises the steps of measuring (10) a slope field (\vec{P}) of the surface by means of a deflectometry device (1) connected to a measurement processing computer, then integrating (20) the slope field by modelling the presence of a rotational component (\vec{A}) in the field, and by jointly searching for a gradient component (ϕ) of said field and alignment errors (\vec{P_{α}}), which consist of rotational components, of the deflectometry device.

The present invention relates to a method for estimating the geometry of a reflective surface of an object, in particular, that of a mirror.

### BACKGROUND OF THE INVENTION

The quality control of a reflective surface of an object can be performed by a deflectometric measurement, the principle of which is illustrated in FIG. 1.

Phase shifting deflectometry is a technique consisting of estimating the geometry of a surface of an object from the deformation of a test pattern image reflected by the surface of the object.

For that, a screen displays a test pattern constituted of a sinusoidal profile horizontal fringe network, and a camera is arranged to capture an image of the fringe network reflected by the surface of the object.

The screen plays the role of graduated scale, making it possible to know the ordinate of the light source points of the screen. This ordinate is indeed proportional to the phase of the sinusoid constituting the fringe profile. The phase shift of a regular fringe step makes it possible to evaluate, for each pixel of the camera, the phase of the corresponding light source point and therefore its vertical position.

In the same way, the displaying of a test pattern constituted of a vertical fringe network makes it possible to know the abscissa of the light source points of the screen.

Knowing the relative positions of the screen, the object and the camera, it is thus possible to model the path of the light beams emitted by the screen and therefore to have access to any point of the surface of the object in the direction of the normal on the surface. This makes it possible to measure the slope field of the surface of the object which, once integrated, makes it possible to reconstruct the geometry of said surface of the object. It is reminded that the slope field comprises a gradient-type component and a rotational-type component, and can be modelled as follows:

$$\vec{P} = \vec{∇} ϕ + \vec{rot} \vec{A}$$

where ϕ and \vec{A} are respectively the gradient component and the rotational component of the slope field \vec{P}.

There are two integration methods: the so-called “modal” method, which consists of estimating the geometry of the surface as the sum of predefined polynomials, such as Legendre or Zernike polynomials; and the so-called “zonal” method, which consists of estimating the geometry of the surface for each pixel of the camera.

The modal integration method comes back to projecting the slope field measured on a polynomial base, and can thus prove to not be very accurate for reconstructing high-frequency spatial defects, in other word, deformations varying over a short distance of around one millimetre.

On the contrary, a zonal integration method based, for example, on a Southwell or Fried-type data model, which consists, in its simplest version, of resolving the opposite problem, by the least squares method, is to be favoured for reconstructing high-frequency spatial defects.

However, such an integration method does not consider rotational components of the measured slope field, which can generate a significant reconstruction error of high-frequency defects, in particular when the rotational components of the measured slope field dominate the gradient components of said field.

What is more, in the scope of a deflectometry performed with a non-calibrated device, alignment errors of the device are at the origin of a significant rotational component of the measured slope field, which can be limiting for the geometric reconstruction of an optical surface, in particular coming from Freeform technology, or highly aspherical.

### AIM OF THE INVENTION

The invention therefore aims to improve the estimation of the geometry of a reflective surface of an object, by limiting the impact of the abovementioned disadvantages.

### SUMMARY OF THE INVENTION

To this end, the invention proposes a method for estimating a geometry of a reflective surface. The method comprises the steps of measuring a slope field of the surface by a deflectometric device connected to a measurement processing computer, then of integrating the slope field by modelling the presence of a rotational component in the field, and by jointly searching for a gradient component of said field and of rotational components of alignment errors of the deflectometric device. This constitutes a self-calibration of the alignment errors.

According to a particular embodiment, the integration step is carried out by using the following equation (E):

$$\hat{ϕ} = arg min ( {‖ \vec{D} ϕ ∓ \vec{{P}_{a}} - \vec{P} ‖}^{2} + C ( \vec{{P}_{a}} ) )$$

where:
   \hat{ϕ} is the estimated geometry of the reflective surface;
   ϕ is the gradient component of the slope field \vec{P};
   \vec{D} is a derivation matrix modelling the measurement of the slope field \vec{P};
   C(\vec{P_{α}}) is a term of penalisation based on the alignment errors \vec{P_{α}} of the deflectometric device;
and with C(\vec{P_{α}})=μ∥div\vec{P_{α}}∥², where μ is a regularisation coefficient, in order to ensure that div \vec{P_{α}} is close to zero.

Such an equation is insensitive to the presence of a rotational component in the slope field, which makes it possible to accurately estimate the geometry of the reflective surface, in particular, when this is highly aspherical.

According to another particular embodiment, the integration step is carried out by using the following equation (E):

$$\hat{ϕ} = arg min ( {‖ \vec{D} ϕ ∓ \vec{{P}_{a}} - \vec{P} ‖}^{2} + C ( \vec{{P}_{a}} ) + R ( ϕ ) )$$

where:
   \hat{ϕ} is the estimated geometry of the reflective surface;
   ϕ is the gradient component of the slope field \vec{P};
   \vec{D} is a derivation matrix modelling the measurement of the slope field \vec{P};
   C(\vec{P_{α}}) is a term of penalisation based on the alignment errors \vec{P_{α}} of the deflectometric device;
   R(ϕ) is a term of regularisation;
and with C(\vec{P_{α}})=μ∥div \vec{P_{α}}∥² where μ is a first regularisation coefficient.

Particularly, the term of regularisation R(ϕ) is based on a power spectral density of the estimated geometry of the reflective surface.

Particularly, R(ϕ)=λ∥\vec{D′}ϕ∥ⁿ with n≥2 and where \vec{D′} is a differentiation matrix, and A is a second regularisation coefficient.

Particularly, R(ϕ)=λ∥ϕ∥².

Particularly, the reflective surface is a mirror.

Particularly, the mirror is an aspherical mirror.

### BRIEF DESCRIPTION OF THE DRAWINGS

The invention will be best understood in the light of the following description, which is purely illustrative and non-limiting, and must be read regarding the accompanying drawings, among which:

FIG. 1 is a principle view of a deflectometric device;

FIG. 2 is a schematic view of the method of the invention;

FIG. 3A is a chart representing an estimated geometry of an aspherical concave mirror according to a particular embodiment of the method of the invention;

FIG. 3B is a view similar to FIG. 3A, representing the estimated geometry of the mirror according to a deflectometric measurement using the Southwell integration method;

FIG. 3C is a view similar to FIG. 3A, representing the estimated geometry of the mirror according to a phase shift interferometric measurement; and

FIG. 3D is a view similar to FIG. 3A, representing a difference between the interferometric measurement illustrated in FIG. 3C and the measurement illustrated in FIG. 3A.

### DETAILED DESCRIPTION OF THE INVENTION

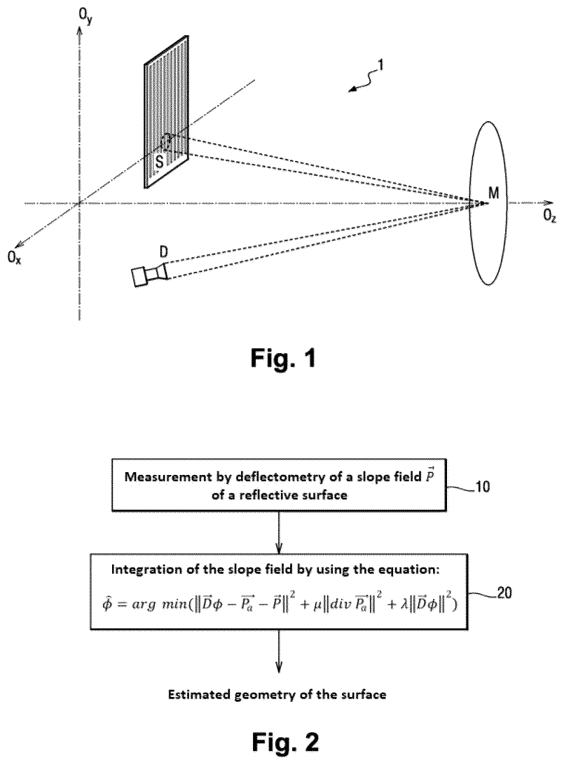

In reference to FIG. 1, a mirror M comprises a reflective surface, for which the quality is sought to be controlled by a deflectometric device 1. The deflectometric device 1 comprises a screen S arranged to display a test pattern and a camera D arranged to capture an image of the test pattern reflected by the surface of the mirror M. The test pattern is constituted of a vertical periodic pattern comprising an alternation of dark and clear fringes with a sinusoidal profile, extending about an axis Oy.

A technique known per se consisting of regularly phase-shifting the fringes makes it possible to evaluate, for each pixel of the camera D, the phase of the corresponding light source point of the screen S, and therefore its horizontal position about an axis Ox.

In the same way, the display of a test pattern constituted of a horizontal periodic pattern with a sinusoidal profile makes it possible to evaluate the vertical position of the light source points of the screen S about the axis Oy.

Knowing the relative positions of the screen S, of the mirror M and of the camera D, it is thus possible to model the path of the light beams emitted by the screen S and therefore to have access to any point of the surface of the mirror M in the direction of the normal.

To this end, the deflectometric device 1 is connected to a computer comprising a processor and a memory containing a program which can be executed by the processor. The program contains instructions arranged to implement the method of the invention. This method comprises the step 10 of measuring a slope field \vec{P} of the surface of the mirror M, then the step 20 of integrating the slope field \vec{P} in order to reconstruct the geometry of said surface of the mirror M.

The slope field \vec{P} is defined as follows:

$$\vec{P} = \vec{∇} ϕ + \vec{rot} \vec{A}$$

where ϕ and \vec{A} are respectively the gradient component and the rotational component of the slope field \vec{P}.

The integration 20 of the slope field P is achieved by the following equation E:

$$\hat{ϕ} = arg min ( {‖ \vec{D} ϕ ∓ \vec{{P}_{a}} - \vec{P} ‖}^{2} + C ( \vec{{P}_{a}} ) + R ( ϕ ) )$$

where:
   \hat{ϕ} is the estimated geometry of the reflective surface of the mirror M;
   \vec{D} is a derivation matrix;
   C(\vec{P_{α}}) is a term of penalisation based on the alignment errors \vec{P_{α}} of the deflectometric device 1; and
   R(ϕ) is a term called regularisation involving a regularity to the sought solution, and in this case, based on a power spectral density of the estimated geometry of the surface of the mirror M;
and with C(\vec{P_{α}})=μ∥div \vec{P_{α}}∥² and for example, R(ϕ)=λ∥\vec{D′}ϕ∥² where μ and λ are regularisation coefficients and \vec{D′} is a differentiation matrix applied to the gradient component ϕ of the slope field \vec{P}, as it is conventional in the opposite regularised problems.

It is understood that the operatory sign “∓” used in the first part of the equation E, arg min(∥\vec{D}ϕ∓\vec{P_{α}}−\vec{P}∥²), means that the equation E can be written:

$$\hat{ϕ} = arg min ( {‖ \vec{D} ϕ - \vec{{P}_{a}} - \vec{P} ‖}^{2} + C ( \vec{{P}_{a}} ) + R ( ϕ ) )$$

$$or$$

$$\hat{ϕ} = arg min ( {‖ \vec{D} ϕ + \vec{{P}_{a}} - \vec{P} ‖}^{2} + C ( \vec{{P}_{a}} ) + R ( ϕ ) )$$

This notes a modelling choice: if it is considered that the alignment errors belong to the measured slopes, \vec{P}≈\vec{D}ϕ+\vec{Pα} is modelled; if it is considered that the alignment errors belong to the modelled slopes, \vec{P}≈\vec{D}ϕ−\vec{Pα} is modelled.

It is also understood that the first part of the equation E, arg min(∥\vec{D}ϕ∓\vec{Pα}−\vec{P}∥²), is a “raw” estimation of the shape and of the rotational components based on the calibration method.

To be able to implement the method of the invention, the components \vec{P_{α}} of the alignment errors of the deflectometric mounting must have been modelled beforehand, for example, by measuring the slope field of a known shape surface. The components \vec{P_{α}} of the alignment errors are physically characterised by a limited number of polynomials calculated analytically. The alignment terms are thus described by a set ca of coefficients and a polynomial matrix \vec{M_{α}} such as \vec{P_{α}}=\vec{M_{α}}c_{α}. The alignment errors comprise a gradient component and a rotational component. The term of penalisation C(\vec{P_{α}}) introduced as an additional term to the least squares criterion, aims to remove from the estimated geometry \hat{ϕ} the rotational component due to the alignment errors P of the deflectometric mounting 1.

The term of regularisation R(ϕ) aims to stabilise the inversion (zonal, therefore with a large number of unknowns) by the introduction of physical hypotheses. The addition of such a term of regularisation is interpreted in the sense of Bayes probabilities as the hypothesis retained in this case, that the power spectral density of the estimated shape of the mirror decreases like a power law, of −2 to −4, for example. This hypothesis has been chosen to correspond to the particular polishing conditions of the surface of the mirror M, which is sought to estimate the shape. Any regularisation criterion based on the power spectral density and making it possible to regularise the problem can be chosen.

It will be noted that in the hypothesis where the power spectral density of the estimated geometry of the surface of the mirror M is uniform, the term of regularisation R(ϕ) becomes R(ϕ)=λ∥ϕ∥².

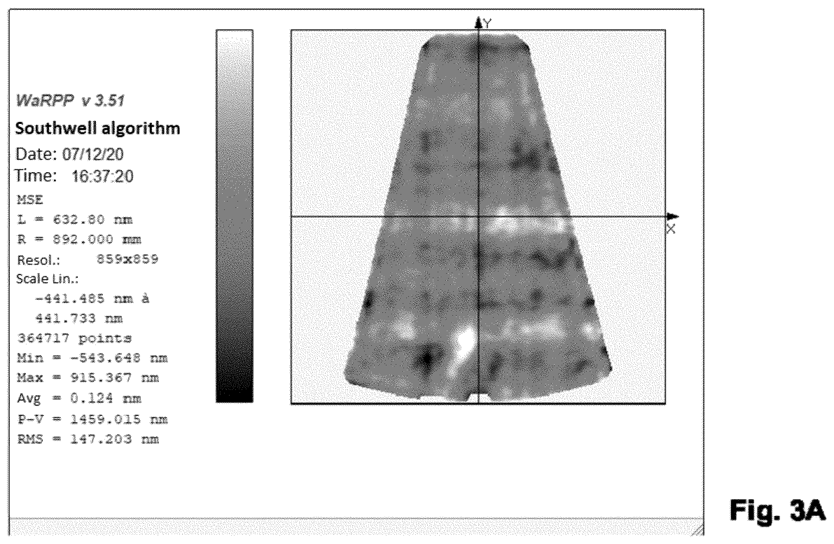

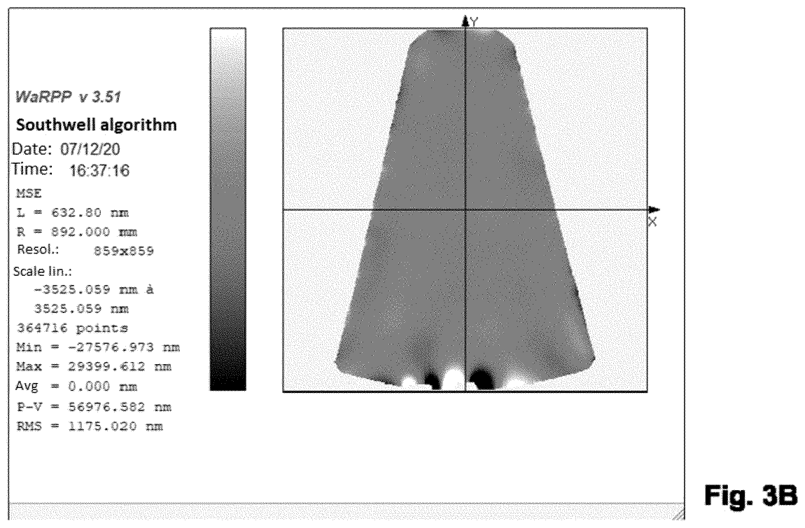

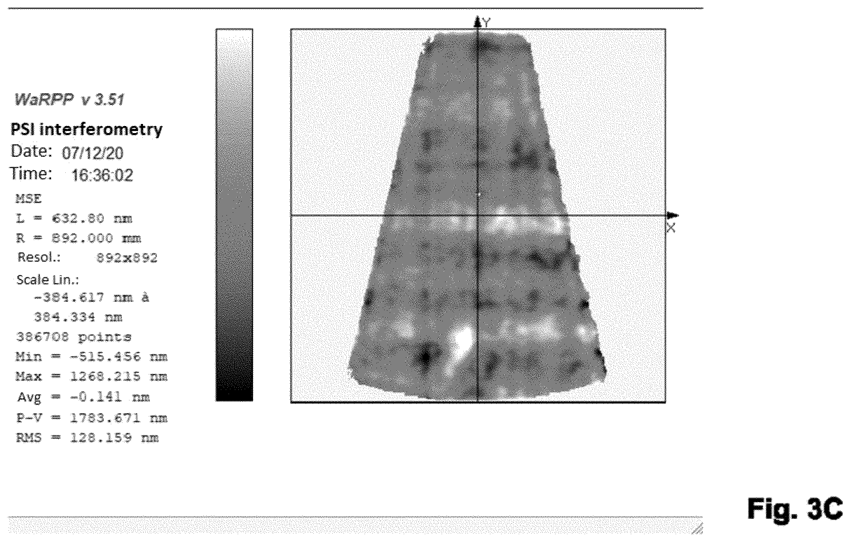

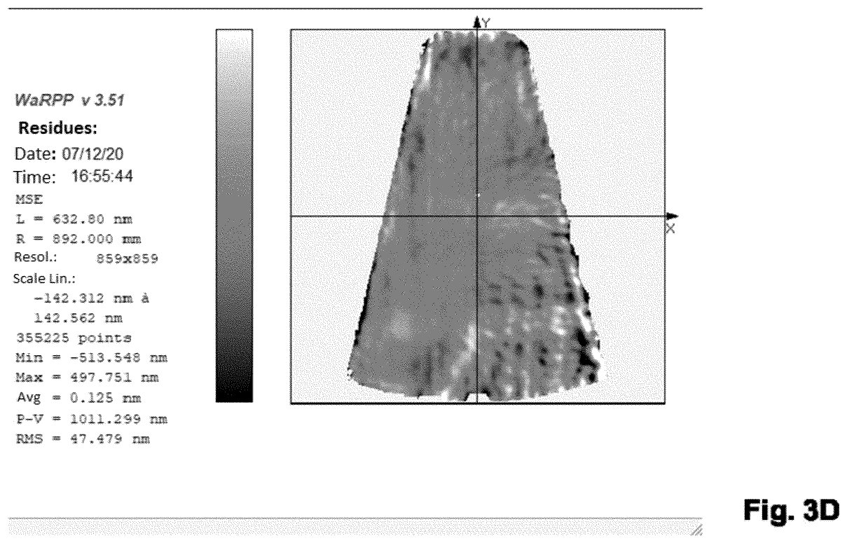

FIGS. 3A to 3D illustrate the effectiveness of the integration of the slope field P by the equation E.

FIG. 3A represents a chart of the geometry of a two-metre mirror M of estimated diameter by a deflectometric measurement using the deflectometric device 1 and the equation E. The screen S is a non-calibrated nineteen-inch screen having a resolution of 1280×1024 pixels, and the camera D is a camera having a 1.3 megapixel sensor and an image frequency of 30 FPS. The slope field \vec{P} has been integrated based on the equation E, by minimising the criterion ∥\vec{D}ϕ∓\vec{P_{α}}−\vec{P}∥²+λ∥\vec{D′}ϕ∥² by hollow matrix-type methods and with μ=10⁹ mm² and λ=4,4·10⁻¹⁰ mm². The regularisation coefficients μ and λ are in this case defined empirically.

The chart illustrated in FIG. 3B differs from that illustrated in FIG. 3A, in that the geometry of the mirror M is estimated by a deflectometric measurement using the Southwell equation, namely \hat{ϕ}=arg min(∥\vec{D}ϕ−\vec{P}∥²), and not that of the equation E.

While the chart illustrated in FIG. 3A shows a high frequency defect of around 147 nm (nanometres) in square deviation, the chart illustrated in FIG. 3B shows a high frequency defect of around 1175 nm in square deviation. The high frequency defects thus appear less visible in FIG. 3B that in FIG. 3A.

The chart illustrated in FIG. 3C differs from that illustrated in FIG. 3A, in that the geometry of the mirror M is estimated by a so-called “PSI” (Phase Shift Interferometry) measurement. The chart illustrated in FIG. 3C shows a high frequency defect of around 128 nm in square deviation, in other words, relatively close to that noted in FIG. 3A. The actual high frequency defects of the mirror thus appear as visible in FIG. 3C as they are in FIG. 3A.

The chart of FIG. 3D, also called “Residues” represents the difference between the deflectometric measurement using the equation E illustrated in FIG. 3A and the interferometric measurement illustrated in FIG. 3C. The measurement relating to the high spatial frequencies of the mirror M, the first thirty-six Legendre polynomials have been subtracted in each of the charts of FIGS. 3A and 3C. The difference between the two measurements is around 47.5 nm in square error.

Subsequently, the deflectometric measurement using the equation E is effective and makes it possible to greatly increase the measurement dynamic of the deflectometry, in particular on aspherical mirrors.

Naturally, the invention is not limited to the embodiments described, but includes any variant entering into the field of the invention, such as defined by the claims.

Although, in this case, the slope field P has been integrated based on the equation E by hollow matrix-type methods, other methods can be used to minimise the criterion ∥\vec{D}ϕ∓\vec{P_{α}}−\vec{P}∥+C(\vec{P_{α}})+R(ϕ): gradient descent, Newton-like, simulated annealing, matrix-type, etc.

Any form of regularisation can be used. The term of regularisation R(ϕ) can, in particular, be chosen independently of any measurement.

For example, R(ϕ)=λ∥\vec{D′}ϕ∥ⁿ can be had with n≥2.

1. Method for estimating a geometry of a reflective surface, comprising the steps of measuring (10) a slope field (\vec{P}) of the surface by a deflectometric device (1) connected to a measurement processing computer, then of integrating (20) the slope field by modelling the presence of a rotational component (\vec{A}) in the field, and by jointly searching for a gradient component (ϕ) of said field and rotational components of alignment errors (\vec{P_{α}}) of the deflectometric device.

2. Method according to claim 1, wherein the integration step is carried out by using the following equation (E):
$$\hat{ϕ} = arg min ( {‖ \vec{D} ϕ ∓ \vec{{P}_{a}} - \vec{P} ‖}^{2} + C ( \vec{{P}_{a}} ) )$$
where:
\hat{ϕ} is the estimated geometry of the reflective surface;
ϕ is the gradient component of the slope field \vec{P};
\vec{D} is a derivation matrix modelling the measurement of the slope field \vec{P};
C(\vec{P_{α}}) is a term of penalisation based on the alignment errors \vec{P_{α}} of the deflectometric device 1;
and with C(\vec{P_{α}}) μ∥div\vec{P_{α}}∥² where μ is a regularisation coefficient.

3. Method according to claim 1, wherein the integration step is carried out by using the following equation (E):
$$\hat{ϕ} = arg min ( {‖ \vec{D} ϕ ∓ \vec{{P}_{a}} - \vec{P} ‖}^{2} + C ( \vec{{P}_{a}} ) + R ( ϕ ) )$$
where:
\hat{ϕ} is the estimated geometry of the reflective surface;
ϕ is the gradient component of the slope field \vec{P};
\vec{D} is a derivation matrix modelling the measurement of the slope field \vec{P};
C(\vec{P_{α}}) is a term of penalisation based on the alignment errors \vec{P_{α}} of the deflectometric device 1;
R(ϕ) is a term of regularisation;
and with C(\vec{P_{α}})=∥div\vec{P_{α}}∥² where at is a first regularisation coefficient.

4. Method according to claim 3, wherein the term of regularisation R(ϕ) is based on a power spectral density of the estimated geometry of the reflective surface.

5. Method according to claim 4, wherein R(ϕ)=λ∥\vec{D′} ϕ∥ⁿ with n≥2 and where \vec{D¹} is a differentiation matrix and λ is a second regularisation coefficient.

6. Method according to claim 5, wherein R(ϕ)=λ∥ϕ∥².

7. Method according to claim 1, wherein the reflective surface is a mirror (M).

8. Method according to claim 3, wherein the mirror (M) is an aspherical mirror.
